(19) United States
(12) Patent Application Publication
(10) Pub. No.: US 2016/0371887 A1
(43) Pub. Date: Dec. 22, 2016

(54) AUGMENTED REALITY METHOD AND SYSTEM FOR MONITORING

(71) Applicant: SNECMA, Paris (FR)

(72) Inventor: Serge Daniel LE GONIDEC, Vernon (FR)

(73) Assignee: SNECMA, Paris (FR)

(21) Appl. No.: 14/902,180

(22) PCT Filed: Jun. 27, 2014
(86) PCT No.: PCT/FR2014/051639

§ 371 Date: Dec. 30, 2015

(30) Foreign Application Priority Data
Jul. 3, 2013 (FR) 1356483

(51) Int. Cl. G06T 19/00; G06T 15/20; G06T 7/00

(52) U.S. Cl. CPC G06T 19/006; G06T 7/004; G06T 15/20; G06T 7/0004; G06T 2200/04; G06T 2207/30108

(57) ABSTRACT

A method for displaying image for the supervision of a device (20) by means of a system comprising a display (14) and cameras (24). The method comprises the following steps: a0) a state parameter of the device is acquired; a1) an active camera is selected; a2) acquired image parameters and synthesis image parameters are determined; b2) a camera image is acquired according to the acquired image parameters; c) a synthesis image of the device is calculated according to the synthesis image parameters; d) the acquired image and the synthesis image are combined realistically to form a supervision image which is displayed. At step a2), the image parameters are determined, and/or at step c), the synthesis image is calculated, and/or at step d), the supervision image is formed, as a function of the state parameter of the device. A supervision system for carrying out the method.

The invention relates to a display method of a supervision image, and a supervision system for the supervision of a device. This device can be an industrial tool, a machine, a vehicle, a living being, a building, etc.

The supervision can take place either in normal operating mode of the device, or when the device is subjected to tests, or any other specific circumstance.

The invention can especially be used for supervision of motors, and more particularly turbomachines or rocket motors, when they are subjected to tests.

In the industrial world, the supervision of the operation of a device, a production unit for example, is generally carried out by means of a supervision system, under the responsibility of supervision staff.

Such a supervision system comprises generally video surveillance means, comprising one or more cameras, whereof the images are displayed on one or more monitors.

The supervision system can also comprise monitors on which diagrams are displayed, for example fluid circulation diagrams, and on which the values of critical parameters of the production unit are displayed in real time.

The supervision system can also comprise a tracking (or monitoring) system which monitors different parameters of the device and sends alert messages signaling any malfunctions. These messages can be displayed on the fluid circulation diagrams cited previously.

The supervision staff analyses in real time the images received from the cameras and the received messages. As a function of these messages, it can especially modify the viewing angle of one of the cameras or even zoom in on specific parts of the supervised production unit.

In the event of anomaly or malfunction, many error or anomaly messages are displayed almost simultaneously by the supervision system. Given the considerable amount of information displayed, it is difficult for the supervision staff to sufficiently and rapidly assimilate the information, select the pertinent information and make the optimal decision.

In particular, the important information is distributed over several monitors (video monitors showing the images taken by cameras, monitors showing fluid circulation diagrams, monitors optionally displaying alert messages and values of the critical variables of the device, . . . ), which complicates the work of the supervision staff in understanding the situation and making the necessary decisions.

Also, a first aim of the present invention is to propose a display method for the supervision of a device by means of a supervision system, which enables optimised display of information relative to a supervised device so as to make the latter easier to understand by the supervision staff.

To achieve this aim, according to a first aspect of the invention a supervision image display method for the supervision of a device by means of a supervision system is proposed, the supervision system comprising a display and at least one real camera arranged so as to be able to film all or part of the device.

The display method comprises the following steps:

a0) at least one state parameter of the device is acquired

a1) if the system comprises a plurality of cameras, a camera called an active camera is selected from the cameras;

a2) two sets of image parameters are determined, specifically a set of acquired image parameters and a set of synthesis image parameters, each set of image parameters comprising a relative camera position and orientation relative to the device, and one or more optical parameter(s) of camera;

b2) an acquired image showing all or part of the device is acquired by means of the active camera and according to the acquired image parameters;

c) a synthesis image of the device is calculated or part of the device such as a virtual camera could provide taking into account the synthesis image parameters;

d) an image called supervision image is formed from the acquired image and the synthesis image such that the acquired image and the synthesis image are combined realistically to form the supervision image; and

e) the supervision image is displayed on the display.

Also, at step a2) the image parameters are determined as a function of said at least one state parameter of the device, and/or at step c) the synthesis image is calculated as a function of said at least one state parameter of the device, and/or at step d) the supervision image is formed as a function of said at least one state parameter of the device.

Preferably (but not necessarily), the display method is executed in real time, allowing the supervision image displayed on the display to be updated in real time. The display displays a film or video sequence which presents the evolution of the device in real time.

The display method uses two types of images: the images acquired, which are images acquired by the (real) camera(s), and synthesis images showing the device. The synthesis images are calculated by means of a three-dimensional digital model of the device (or at least part of the latter).

Highly schematically, the display method according to the invention consists therefore of acquiring an image of the device by means of a real camera (the active camera), calculating a synthesis image showing all or part of the device, and combining the acquired image and the synthesis image to form a supervision image which is then displayed.

It is clear that the combination of the acquired image and of the synthesis image is made so as to retain the most important information relative to the device in the supervision image.

So, the acquired combined image presents on a single display or monitor, at any time, the most pertinent representation of the device.

In normal operation, the displayed supervision image can be an external ensemble view of the device, such as acquired by one of the cameras.

However the display method according to the invention demultiplies the display possibilities, adding to the information coming from the cameras (the acquired images) additional information which is integrated into the synthesis image. The resulting supervision image comprises an extremely rich image, particularly useful for comprehension of the behaviour of the supervised device. The synthesis image can serve for example to represent hidden inner parts of the device.

It is generally possible to reduce the number of monitors necessary to ensure supervision of the device by the richness and amount of information contained in the supervision image.

Also, the supervision image is advantageously formed as a function of the state of the device, since either the determination of the image parameters or calculation of the synthesis image or formation of the supervision image is (or are) carried out as a function of the state parameter(s) of the device.

For this purpose specific sets of image parameters, and/or a calculation mode of the specific synthesis image, and/or a mode of formation of specific supervision image should naturally be preselected, which is/are adapted so that when the device is in a certain predetermined state, the supervision image formed is particularly pertinent for interpreting the state of the device and enabling supervision of the latter.

This mode of operation makes it possible to submit to the supervisor a particularly pertinent synthesis image, and typically reduces the time spent by the supervisor for analysing the state of the supervised device, identifying malfunctions and triggering adapted corrective actions.

### Image Parameters

The image parameters (orientation and position of the camera relative to the device; optical parameters of the camera) are the parameters which determine what appears in the image of a camera. They in fact specify where the camera is positioned, how it is oriented and what its optical parameters are (zoom, etc.).

The acquired image parameters define what will appear in the image acquired by the active camera, and the synthesis image parameters define which image will be calculated during the synthesis image calculation step c).

The image parameters can therefore relate to a real camera or even a virtual camera producing an image en being positioned in a virtual scene.

Determination step a2) of the image parameters can be a passive step during which the selected (active camera) or determined (image parameters) elements either assume values by default or are repeated and retain the value taken during the preceding iteration of the program executed by the supervision system.

The choice of the active camera in some cases determines by itself the two sets of image parameters when for the two sets of parameters (acquired image and synthesis image) the image parameters are taken during the active camera, which is what happens most often.

However, there can also be some differences between the acquired image parameters and the synthesis image parameters.

The acquired image parameters and the synthesis image parameters can for example be different:
for compensating positioning and/or orientation error and/or in the optical parameters of the active camera; and/or
because the synthesis image represents only a portion of the active image.

### Synthesis Image

The synthesis images are images of the device or part of the device such as a virtual camera could provide. These are in fact rendered images obtained (as is known per se) from a virtual scene containing the three-dimensional digital model of the device (or part of the latter), and in which one or more ‘virtual cameras’ are positioned.

In some cases, it can be opportune for there to be differences between the virtual scene and the real device.

For example, the virtual scene can optionally comprise digital models of objects other than the device subjected to testing. It can for example, in the case of a rocket motor operation test comprise models of fuel tanks of the motor, etc., in the event where the representation of these objects makes it easy to understand the image for supervision staff.

On the other hand, in the synthesis image the device optionally can be incomplete (or equivalently parts of the device can be made transparent to the monitor).

In other cases, the device can be positioned in the virtual scene differently to reality; for example in ‘exploded’ position to allow more readable representation of the constitution of the device.

Also, the synthesis image is generally enriched by additional information superposed on the visual rendering of the digital model of the device. This additional information can especially vary in real time. This additional information is normally integrated into the synthesis image in the vicinity of the point of the image it relates to.

This additional information can be a representation, positioned on the device itself, of the field of variations of some parameters of the device.

This representation can be completed in ‘false colours’, that is, with different colours conventionally associated with different ranges of values of the parameter shown.

This additional information can finally comprise symbolic, especially verbal, information.

By way of additional information which it integrates, and/or the fact that it shows non-visible parts of the device (or much less visible) by the real cameras, the synthesis image lets the supervision staff better understand the physical phenomena underway in the device and consequently more easily understand how the latter evolves.

### Combination of the Acquired Image and the Calculated Image

In the supervision image, the acquired image and the synthesis image can be combined in different ways.

These two images can be superposed by using partially transparent layers. It is also possible that the synthesis image and the acquired image are complementary; for example in the supervision image all the pixels relative to a specific piece of the device can come from the synthesis image, the other pixels coming from the acquired image.

The supervision image can combine different layers corresponding respectively to the acquired image and the synthesis image, by using transparency.

Naturally, the display method is all the more effective since the acquired image and the synthesis image are combined realistically in the supervision image.

The fact that these two images are combined realistically means that when these two images are combined, they form an image in which the part of the device shown by the synthesis image appears in a relative normal position, or at least which appears normal, relative to the part of the device (or the rest of the device) shown by the image acquired by the camera.

It can happen that when the method is being executed the image initially calculated at step c) cannot be combined realistically with the image acquired by the camera.

To rectify this problem, in an embodiment of the method according to the invention during step d) the synthesis image is modified and/or recalculated such that the acquired image and the synthesis image are combined realistically to form the supervision image.

First of all it should be noted that it is indispensable for the acquired image and the synthesis image to correspond perfectly. Advantageously the supervision image retains its interest even if there are some differences between the acquired image and the synthesis image.

These differences can first of all, if of minimal importance, be overcome by carrying out redimensioning of the synthesis image, that is, by applying dilation or contraction according to its two directions, and optionally rotation.

If the differences between the acquired image and the synthesis image are considerable this can come from errors as to the effective image acquisition parameters by the active camera.

In practice, the image parameters of the cameras are known to the measuring errors of these parameters. There can therefore be a spread between the theoretical image parameters and the effective image parameters for the acquired image.

In this case, at step d) it is necessary to identify from the acquired image the real image parameters of the latter; to update from the effective parameters of the acquired image the synthesis image parameters; to recalculate the synthesis image taking into account the updated synthesis image parameters, and finally to recalculate the supervision image.

In the display method, a certain number of choices is generally left under the control of the supervision staff: in particular, the choice of the active camera the image of which is displayed on the display, and the parameters of the latter (position, orientation, optical parameters).

In some cases, it can be decided to display a supervision image in which the device is filmed with a camera position or orientation, or even optical parameter of cameras, which do not correspond to the parameters from the different cameras.

In this case, the supervision image displaying method can be executed as follows: at step a2) image parameters are determined which are not those of any of the real cameras at the relevant instant; and prior to acquiring the acquired image at step b2), during a step b1) the parameters of the active camera are adapted such that they correspond substantially to the image parameters determined at step a2).

So in this embodiment, the image parameters are imposed on the camera so as to assume the new preferred values. In other terms, the type of preferred supervision image is selected in advance (the specific position and orientation of the camera relative to the device, its degree of zoom, etc.); the active camera is selected as a function of this choice, and the active camera is positioned, oriented and adjusted as a function of this choice.

Also, the way in which the acquired image and the synthesis image are combined is generally specified by the supervision staff during operation of the supervision system. This can for example have at its disposition functions for displaying the synthesis image, and in the latter, render transparent (or invisible to the monitor) the components of the device it does not want to see as well as display functions of specific parameters of the device.

On the other hand, in addition to these possibilities, the supervision image display method in keeping with the invention has the capacity to automatically modify the display in some circumstances.

With this aim, the supervision system is informed of the evolution of the device by step a0) of the method, during which one or more state parameters of the device is acquired. The supervision system can for example receive state parameters of the device transmitted by a tracking system of the device (called health tracking system or ‘Health monitoring system’), preferably periodically and in real time.

Following acquisition of this or these state parameter(s) and in keeping with the invention, at least one of the following operations occurring in obtaining the supervision image is done as a function of the state parameter(s) of the device:
at step a2) the image parameters are determined, and/or
at step c) the synthesis image is calculated, and/or
at step d) the supervision image is formed.

The parameter(s) of the device are parameters variable as a function of time. These parameters can be or comprise default or malfunction information of the device. This information can be for example an alert or alarm message generated by the tracking system of the device.

In an embodiment, the image parameters are adjusted and/or the synthesis image and/or the supervision image are recalculated preferably in real time, after any variation of a state parameter of the device justifying a change in displaying the supervision system. So the supervision staff is informed in real time, on the display, of any evolution of the supervised device.

In particular, at step a2) the image parameters can be modified, and/or at step c) the synthesis image can be recalculated, and/or at step d), the supervision image can be formed again when a state parameter of the device acquired at step a0) exceeds a predetermined threshold.

The supervision image is therefore itself a function of the detected anomaly.

The invention also comprises a supervision system for the supervision of a device, comprising a computing unit, a display, tracking means of the device capable of acquiring at least one state parameter of the device, and at least one camera; supervision system in which the computing unit comprises:

a) determination means (or a module) capable of determining image parameters for an image called supervision image, said image parameters comprising a relative camera position and orientation relative to a device filmed by said at least one camera, and one or more optical parameter(s) of camera; and making the choice of a camera called an active camera from several cameras, when the system comprises a plurality of real cameras;

b2) acquisition means capable of acquiring images of the active camera according to the image parameters determined by the determination means;

c) calculation means capable of calculating a synthesis image of the device or part of the device such as a virtual camera could provide taking into account the image parameters determined by the determination means;

d) image formation means, capable of forming an image called a supervision image from the acquired image and the synthesis image such that the acquired image and the synthesis image are combined realistically to form the supervision image; and

the display is capable of (e) displaying the supervision image;

a system in which

the determination means are capable of determining the image parameters as a function of said at least one state parameter of the device; and/or

the calculation means are capable of calculating the synthesis image as a function of said at least one state parameter of the device; and/or

the supervision image formation means are capable of forming the supervision image as a function of said at least one state parameter of the device.

The image parameters for the supervision image are generally a single set of image parameters, used at the same time to acquire images at step b2), and to calculate synthesis images at step c).

These can also be two separate sets of image parameters, specifically a set of acquired image parameters and a set of synthesis image parameters, used respectively for the acquisition of images at step b2) and for the formation of synthesis images at step c).

It is clear that the determination means are capable in this latter case of defining acquired image and synthesis image parameters which are compatible, that is, which at step d) allow the acquired image and the synthesis image produced on the basis of these parameters to be combined realistically.

Equivalently to points b2), c) and d) hereinabove, it can be said that the computing unit is configured to:

b2) acquire images of the active camera according to the image parameters determined by the determination means;

c) calculate a synthesis image of the device or part of the device such as a virtual camera could taking into account the image parameters determined by the determination means;

d) form an image called a supervision image from the acquired image and the synthesis image such that the acquired image and the synthesis image are combined realistically to form the supervision image.

The following refinements can also be adopted, singly or in combination:
the acquisition means can be capable of adjusting at least one parameter of at least one real camera so as to render said parameter equal to an image parameter determined by the computing unit.
the calculation and/or image formation means can be capable of modifying and/or recalculating the synthesis image as a function of the acquired image such that the acquired image and the now modified and/or recalculated image are combined realistically at step d) to form the supervision image.
in the supervision system, the monitoring means can be anomaly-detection means;
the determination means can be capable of determining the image parameters (at step a2) as a function of an anomaly detected on the device.
The monitoring means can in this case comprise anomaly detection means comprising an interpreter of anomalies capable of selecting principal anomaly information from a large amount of available anomaly information, for calculating the image modified as a function of this principal anomaly information.
the calculation means can be capable of calculating the synthesis image at step c) as a function of an anomaly detected on the device.

Within the scope of the invention, a computer program is also proposed comprising instructions for the execution of the steps of the display method such as defined previously, when said program is executed by a computer connected to at least one real camera arranged so as to be able to film all or part of the device.

In the scope of the invention, a recording medium readable by a computer is also proposed on which is recorded a computer program comprising instructions for execution of the steps of the display method such as defined previously when said program is executed by a computer connected to at least one real camera arranged so as to be able to film all or part of the device.

The invention will be better understood and its advantages will emerge more clearly from the following detailed description of embodiments shown by way of non-limiting examples. The description refers to the appended drawings, in which:

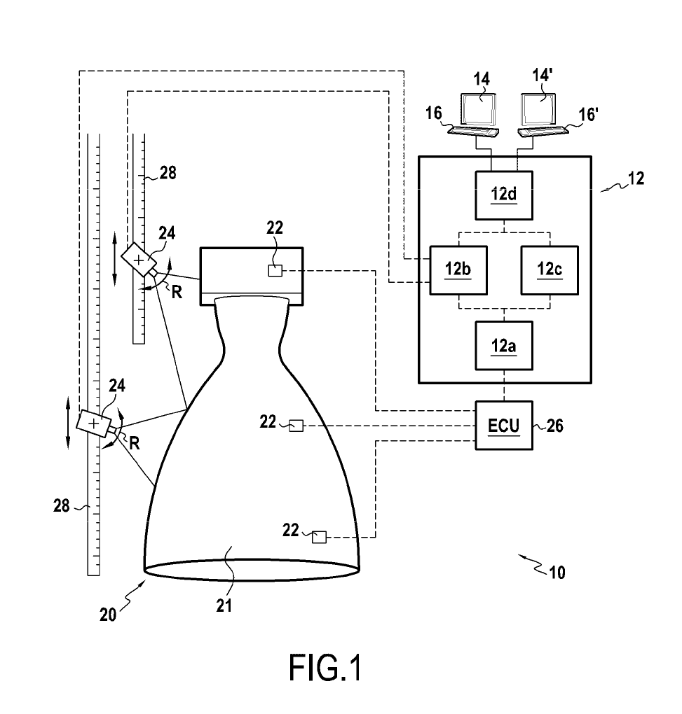

FIG. 1 is a schematic view of a supervision system according to the invention;

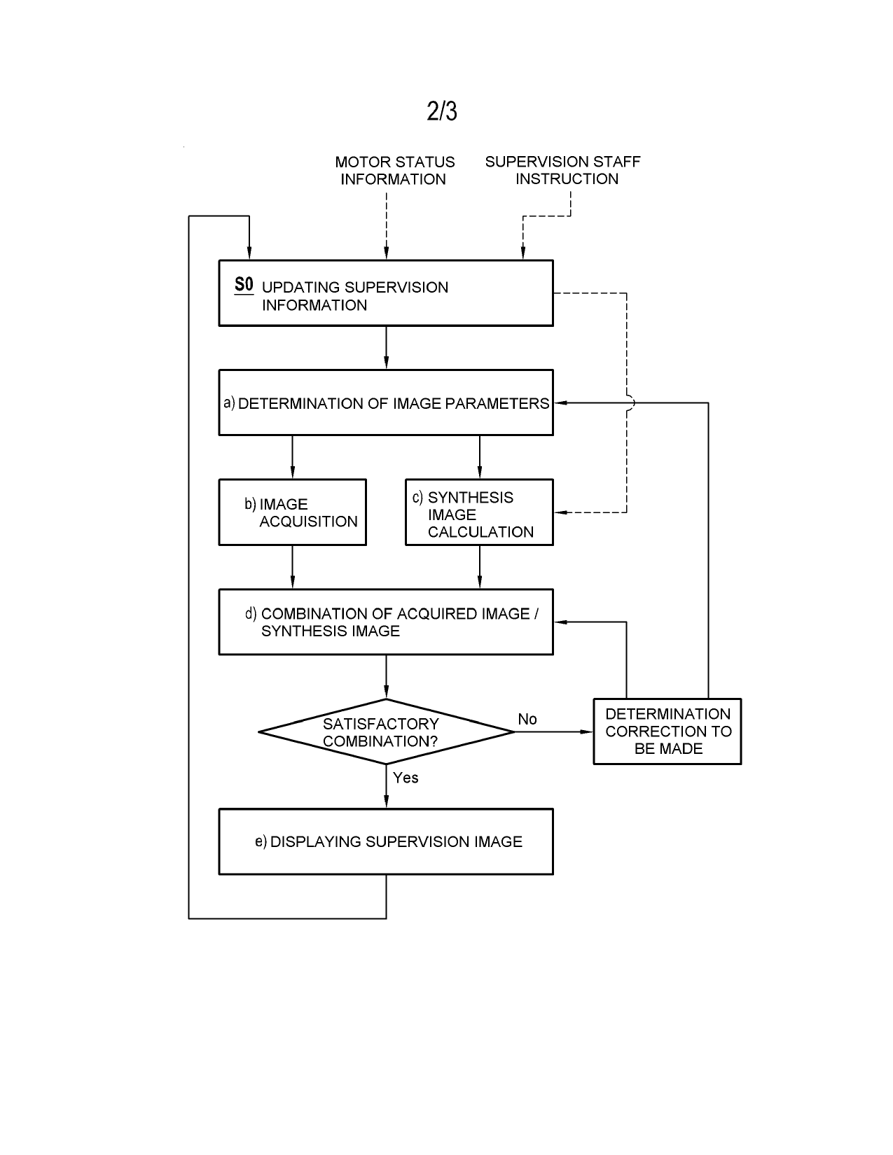

FIG. 2 is a diagram illustrating the steps of the process according to the invention in an embodiment;

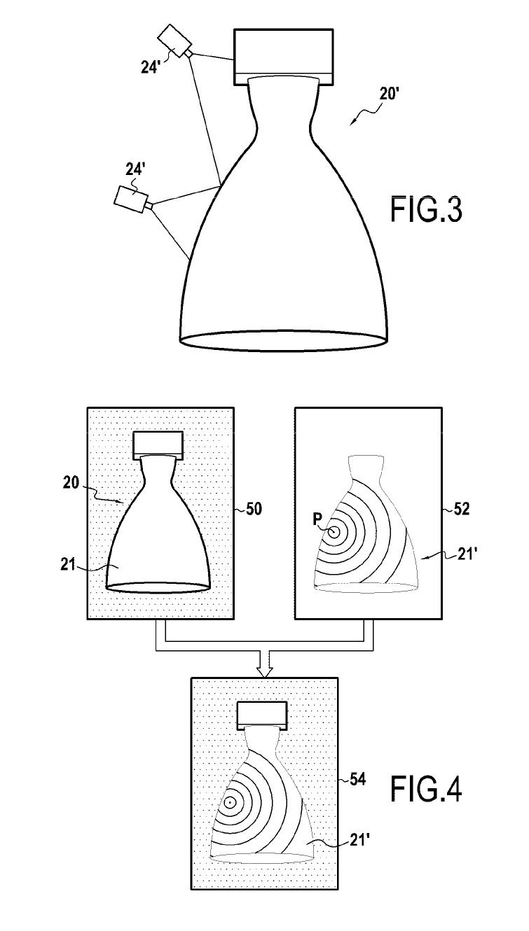

FIG. 3 is a schematic view of a virtual scene used for the image calculation, during execution of the process according to the invention; and

FIG. 4 is a schematic view illustrating the formation of the supervision image from an acquired image and a synthesis image.

A supervision system 10 according to the invention, for the supervision of tests conducted on a rocket motor 20, is shown schematically in FIG. 1.

This supervision system 10 lets supervision staff in charge of testing control, proper testing provided for the motor 20 from a control panel.

The motor 20 is a test rocket motor, comprising a nozzle 21 subjected conventionally to operating tests. It is placed for this purpose on a test bench, not shown.

The motor 20 is equipped with different sensors 22 which constitute monitoring means of the rocket motor (or device) 20. The sensors 22 measure state parameters of the motor such as for example temperatures, pressures, accelerations, etc.

The motor 20 is also placed under the surveillance of different cameras 24.

The sensors 22 are connected to a computer or electronic control unit ('ECU') 26. Its function is to permanently monitor in real time the evolution of the motor 20 during operating tests. The computer 26 constitutes a “healthy monitoring system” of the motor 20. Such a system is described for example by French patent No. FR2956701.

The supervision system 10 comprises a computing unit 12 to which are connected a monitor (or display) 14 and a keypad 16. The supervision system further comprises a second control monitor 14′ and a second keypad 16′.

The computing unit 12 is designed to execute a computer display program enabling displaying on the monitor 14 of supervision images of the motor 20. For this purpose, the computing unit 12 comprises determination means 12a capable of determining the active camera and the image parameters; acquisition means 12b for acquiring the camera images, calculation means 12c for calculating synthesis images of the device, and finally image formation means 12d to form the supervision images from images supplied by the acquisition means and the calculation means.

The acquisition means 12b are also capable of transmitting to the cameras (and to the positioning means which enable their positioning and their orientation) preferred position parameters and optical parameters. They therefore also constitute adjustment means of camera parameters.

### Initialisation of the Display Program

### Creation of the 3D Scene

The display program of the computing unit 12 uses a three-dimensional digital model 20′ of the motor 20 as data. During initialisation of the program, a virtual scene is defined in which the digital model 20′ of the motor 20 is arranged. Virtual cameras 24′, having optical (virtual) characteristics identical to those of the real cameras 24, are positioned in the virtual scene. The resulting virtual scene is illustrated by FIG. 4.

### Parameterising of the Program

Also, a set of predefined behaviours is programmed.

Each predefined behaviour comprises:
a condition or a criterion which is a function of state parameters measured by the sensors 22 (and optionally other magnitudes such as time, etc.), and
the values of image parameters to be used in case the condition or the criterion defined in this way is satisfied.

Accordingly when the system is run, as soon as the predefined condition or the criterion is satisfied, the display and optionally the active camera immediately adopt the image parameters predefined for these conditions. This allows the most adapted display to circumstances to be immediately displayed for the attention of the supervision staff.

The supervision system 10 can for example be programmed to have, in case of detection of an increase in the vibratory level of a motor bearing, the following predefined behaviour:
the image parameters are adjusted such that the active camera is oriented to placement of the bearing and acquires an image with maximal enlargement factor (zoom);
the camera closest to the bearing is selected as active camera, moved close to the bearing, oriented towards the latter; its enlargement factor is made maximal;
an image is acquired by this camera;
the calculation means 12c calculate a synthesis image of the bearing, in which the bearing is shown with a specific colour;
the image formation means 12d combine this synthesis image of the bearing with the acquired image showing the rest of the motor such that the supervision image obtained reveals the synthesis image of the bearing within the overall image of the motor. During formation of the supervision image the synthesis image is placed on a layer placed before the layer containing the image acquired by the camera, such that in the supervision image the synthesis image stays entirely visible.

The supervision system 10 can for example also be programmed to have the following predefined behaviour.

The calculation means can calculate substantially in real time the variations in some parameters in the motor by means of theoretical digital models as a function of the available measurements, for example:
power dissipations;
heat transfers.

After this, the calculation means integrate into the synthesis image a colorised representation of the range of variations of the calculated parameter. This colorised representation can be in the form of a colour gradient even though there is limited number of special instrumentation.

### Execution of the Display Program

The principal steps of the display program are illustrated by FIG. 2.

The display program is an iterative program which permanently executes in a loop steps S0) to e) described hereinbelow, updating the supervision image each time step e) is performed.

### Step a0 Updating of Supervision Information

The initial step a0 of this program consists first of all of acquiring updated values of the state parameters of the motor 20. This information is sent to the computing unit 12 in real time by the computer 26. This information is acquired by determination means 12a of image parameters of the computing unit 12.

This information includes parameter values of the motor, and/or alert messages coming from the computer 26 when abnormal values are raised for some parameters.

Step a0 of the program also consists of acquiring values or instructions specified by the supervision staff, for example the choice of the active camera, or some image parameters for the displayed image. The specified parameters can especially be acquired from image parameters influencing the active camera, and/or synthesis image parameters influencing the synthesis image to be integrated into the image displayed.

### Steps a1) and a2) Determination of the Active Camera and Image Parameters

The first processing steps a1) and a2) are conducted by the determination means 12a of the computing unit 12. These determination means determine the active camera and determine the acquired image and synthesis image parameters. In light of the formation of a supervision image which will then be displayed on the monitor 14, this step consists therefore of determining:
from the different cameras 24, the active camera which will supply a photo of the device or part of;
the acquired image parameters which the acquired image shall have by the active camera, specifically the imaging position and orientation of the latter relative to the motor 20, and the optical parameters which the camera must take, for example the zoom factor; and
the synthesis image parameters which the synthesis image shall have, specifically the imaging position and orientation of the latter relative to the digital model of the motor 20, the specific position(s) of the latter in space (which can differ from the position of the corresponding real pieces), and the optical parameters which the virtual camera must take to produce an image of the virtual scene, such as for example the zoom factor.

Most often, the acquired image parameters are identical to the synthesis image parameters. However, the program executed by the system 10 can be provided so that the image parameters are different for the acquired image and for the synthesis image. This situation can occur for example in the event where the preferred supervision image is an overall image of the motor 20, but where a synthesis image showing only one component of the motor, for example of small size is to be inserted into this overall image. The image parameters of the synthesis image are specified such that the synthesis image shows only the component in question.

On the other hand, most often, the determination means use as image parameters (acquired and synthesis) the image parameters of the active camera 24 used previously. The supervision staff operating the supervision system 10 specifies the active camera by default (used during startup of the system); also, as indicated previously at step S0 it can have specified a new camera as active camera, or have modified the image parameters.

Therefore, taking into account the instructions of the supervision staff, the determination means define the parameters for the acquired and synthesis images.

A particularly interesting property of the supervision system 10 is its behaviour in the event of malfunction of the motor 20 during testing.

If a specific malfunction message (forming part of a predetermined list) is sent to the unit 12 by the computer 26, or if some parameters of the motor 20 exceed some predetermined values, at step a2) the program executed by the computing unit 12 defines itself, automatically, new image parameters.

For example, if some specific malfunction messages relating to a critical component of the motor 20 are received, the determination means automatically consider (without intervention of the supervision staff) image parameters which specifically display on the monitor the component that experiences the malfunction.

The acquired image parameters are adjusted for example so that the active camera is closest to the faulty component that experiences the malfunction; the camera is positioned as closely as possible to this component and oriented towards the latter. The zoom factor (sole optical parameter adjustable on the cameras 24) is adjusted so that the faulty component is visible in the best conditions on the image of the active camera.

### Step b) Acquisition of the Image

This step comprises two sub-steps.

### b1) Adjustment of the Active Camera

After the image parameters have been determined (step a2), in the event where the parameters of the active camera does not correspond to the acquired image parameters, the active camera is adjusted so that its parameters correspond to the preferred acquired image parameters determined by the determination means 12a.

In the presented example, the cameras 24 are mobile in translation according to the vertical axis on racks 28. They are also orientable by rotation about a horizontal axis (arrows R).

Also, to adjust the parameters of the active camera 24, the acquisition means 12b (functioning as camera parameter adaptation means) transmit the preferred acquired image parameters to the active camera 24 and the positioning means of the latter. The positioning means position and orient this camera, and the latter adjusts its inner parameters (especially the zoom factor), in keeping with the transmitted parameters.

### Step b2) Acquisition of the Acquired Image

Once the camera is positioned and adjusted to the acquired image parameters (if needed), the acquisition means 12b perform acquisition of an image of the active camera 24.

### Step c) Calculation of the Synthesis Image

On the other hand, the system 10 calculates the synthesis image according to the synthesis image parameters. This image shows part of the motor 20, or optionally the whole motor 20.

The characteristics of the synthesis image are in general predetermined, or specified by the supervision staff as a function of the parameters it wants to monitor.

Therefore, a default display is defined for each of the components of the motor. This default display can include the representation of some parameters; for example for the nozzle of the motor the rate of vibrations is displayed by default.

The supervision staff can also request displaying of specific parameters.

However, the characteristics of the synthesis image can also, in some circumstances, be defined as a function of the state information of the motor 20.

In this way, in the event where some predetermined malfunction messages are sent, or if some parameters exceed some predetermined values, the calculation means 12c take into account the specific characteristics predetermined for the synthesis image. These specific characteristics are different kinds and can involve:
making transparent some components via which the aim is to be able to see (visible/non-visible component);
positioning some components in specific positions so that the resulting view is more significant (for example, it can be specified that the components of the motor are positioned ‘exploded’ so that the inner parts of the motor are visible;
displaying values of parameters considered to be the most important for supervision staff, if it receives the relevant malfunction message. The values of parameters can be displayed in digital form, or more advantageously with false conventional colours, on the motor itself (or only on some of its components);
representing the default component(s) according to some colours having a predetermined conventional meaning, optionally blinking.

For example, if the temperature at one point of the nozzle exceeds a predetermined value, the calculation means modify the characteristics of the synthesis image so that the temperature information on the nozzle is displayed, that is, the synthesis image is calculated so as to show the variations in the temperature range on the nozzle, as shown in FIG. 4 (This figure shows isothermal curves enclosing a hot point P of the nozzle).

### Step d) Formation of the Supervision Image

Once the acquired image and the synthesis image have been obtained, the image formation means 12d of the unit 12 form the supervision image.

Most often, the acquired image parameters and synthesis image correspond, which ensures that the synthesis image can be combined easily with the acquired image; for example, because the image parameters are exactly the same.

However, it can happen that the combination of the acquired image and the synthesis image fail to produce a realistic image.

After having combined the two images, the display program evaluates if the combination is satisfactory. This evaluation can be done by extraction of ridges in the two images, and evaluation of the correspondence of the ridges between the two images.

If the combination of the acquired image and the synthesis image is satisfactory, the supervision image obtained is sent to the monitor 14.

In the opposite case, the supervision image is recalculated. This recalculation can be done in different ways.

If the differences are minimal, basic image processing such as application of scale factors (‘Scale’ functions) in both directions are applied to the synthesis image so as to have the latter correspond better to the acquired image. Only determination step d) of the supervision image by combination of the acquired and synthesis images is repeated.

If the differences are greater, the synthesis image is recalculated. The computing unit determines new synthesis image parameters, closer to the effective image parameters of the acquired image (step a2).

These new synthesis image parameters can be calculated in different ways.

They can first of all be calculated from the acquired image itself. To this end, targets (for example circular lozenges made of retro-reflective material) can be placed on the motor 20 and the computing unit comprises means for determining the image characteristics of an image simply from the positions of targets appearing in the image.

Alternatively, the synthesis image parameters can be recalculated from the acquired image without the need to integrate targets into the scene. In this aim, the computing unit can comprise means for determining the image characteristics of an image by effecting extraction of contours in the acquired image and applying a form recognition algorithm to the extracted contours.

When the new synthesis image parameters have been fixed, the calculation means 12c again calculate a synthesis image on the basis of these new parameters (step c). The supervision image is formed by combining the acquired image and the new synthesis image (step d).

If the combination of the acquired image with the new synthesis image is satisfactory, the new supervision image is transmitted to the monitor 14. On the contrary, the improvement step of the synthesis image is repeated.

An example of formation of a supervision image is shown in FIG. 4. This shows both an image 50 acquired by a camera 24; this image shows the whole motor 20.

FIG. 4 also shows a synthesis image 52, the latter showing only the nozzle 21 of the motor. This nozzle is shown by means of the digital model 21′ of the nozzle. The digital model 21′ shows the variations in surface temperature of the nozzle, in the form of isothermal curves.

FIG. 4 finally shows the supervision image 54 formed by combination of the acquired image 50 and of the synthesis image 52. In the image 54, the representation of the nozzle comes from the synthesis image 52 (and therefore the digital model 21′, showing the isothermal curves); the rest of the image comes from the image 50 acquired by the camera.

In a variant of the display program, the determination means systematically determine the synthesis image parameters from the acquired image, for example by using targets as indicated previously.

The computing unit 12 functions in real time, that is, all steps a1) to e) are performed in real time.

1. A method for displaying a supervision image for the supervision of a device by means of a supervision system, the supervision system comprising a display and at least one real camera arranged so as to be able to film all or part of the device;
the method comprising the following steps:
a1) a camera called an active camera is selected from several cameras, if the system comprises several cameras;
a2) two sets of image parameters are determined, specifically a set of acquired image parameters and a set of synthesis image parameters, each set of image parameters comprising a relative camera position and orientation relative to the device, and one or more optical parameter(s) of camera;
b2) an acquired image is acquired showing all or part of the device by means of the active camera, according to the acquired image parameters;
c) a synthesis image of the device or part of the device is calculated such as a virtual camera could provide taking into account the synthesis image parameters;
d) an image called supervision image is formed from the acquired image and the synthesis image such that the acquired image and the synthesis image are combined realistically to form the supervision image; and
e) the supervision image is displayed on the display;
the method
further comprising a step a0) during which at least one state parameter of the device is acquired; and wherein
at step a2) the image parameters are determined as a function of said at least one state parameter of the device, and/or
at step c) the synthesis image is calculated as a function of said at least one state parameter of the device, and/or
at step d) the supervision image is formed as a function of said at least one state parameter of the device.

2. The display method according to claim 1, wherein at step a2) image parameters which are not those of any one of the real cameras are determined at the relevant instant; and prior to acquiring the acquired image at step b2), during a step b1) the parameters of the active camera are adapted such that they correspond substantially to the image parameters determined at step a2).

3. The display method according to claim 1, wherein the synthesis image is modified and/or recalculated as a function of the acquired image such that at step d) the acquired image and the synthesis image are combined realistically to form the supervision image.

4. The display method according to claim 1, wherein at step a2) the image parameters are modified, and/or at step c) the synthesis image is recalculated, and/or at step d) the supervision image is formed again when a state parameter of the device acquired at step a0) exceeds a predetermined threshold.

5. A supervision system for the supervision of a device, comprising a computing unit, a display, and at least one camera; supervision system in which the computing unit comprises:
a) determination means, capable of determining image parameters for an image called supervision image, said image parameters comprising a relative camera position and orientation relative to a device filmed by said at least one camera, and one or more optical parameter(s) of camera; and making the choice of a camera called an active camera from several cameras, when the system comprises a plurality of cameras;
b2) acquisition means capable of acquiring images of the active camera according to the image parameters determined by the determination means;
c) calculation means capable of calculating a synthesis image of the device or part of the device such that a virtual camera could provide taking into account the image parameters determined by the determination means;
d) image formation means capable of forming said supervision image from an acquired image and a synthesis image such that the acquired image and the synthesis image are combined realistically to form the supervision image;
and wherein the display is capable of (e) displaying the supervision image;
the further comprising monitoring means of the device, capable of acquiring at least one state parameter of the device;
and wherein
the determination means are capable of determining the image parameters as a function of said at least one state parameter of the device; and/or
the calculation means are capable of calculating the synthesis image as a function of said at least one state parameter of the device; and/or
the supervision image formation means are capable of forming the supervision image as a function of said at least one state parameter of the device.

6. The supervision system according to claim 5, wherein the acquisition means are capable of adjusting at least one parameter of at least one real camera so as to render said parameter equal to an image parameter determined by the computing unit.

7. The supervision system according to claim 5, wherein the calculation and/or image formation means are capable of modifying and/or recalculating the synthesis image as a function of the acquired image such that the acquired image and the now modified and/or recalculated image are combined realistically at step d) to form the supervision image.

8. A computer program comprising instructions for execution of the steps of the display method according to claim 1 when said program is executed by a computer connected to at least one real camera arranged so as to be able to film all or part of the device.

9. A recording medium readable by a computer on which is recorded a computer program comprising instructions for execution of the steps of the display method according to claim 1 when said program is executed by a computer connected to at least one real camera arranged so as to be able to film all or part of the device.
